(19) United States
(12) Patent Application Publication
(10) Pub. No.: US 2001/0028479 A1
(43) Pub. Date: Oct. 11, 2001

(54) Exposure recording apparatus and method of adjusting the amount of light therein

(76) Inventor: Ichirou Miyagawa, Minamiashigara-shi (JP)

Correspondence Address: SUGHRUE, MION, ZINN, MACPEAK & SEAS, PLLC, 2100 Pennsylvania Avenue, N.W., Washington, DC, 20037-3213, US

(21) Appl. No.: 09/828,163

(22) Filed: Apr. 9, 2001

(30) Foreign Application Priority Data
Apr. 10, 2000 (JP) 2000-108560

(51) Int. Cl. H04N 1/40

(52) U.S. Cl. 358/471

(57) ABSTRACT

Photosensors are inserted as amount-of-light detecting units between light sources and a photosensitive medium by a moving mechanism, and detect amounts of light of light beams emitted from the respective light sources. In order to equalize the detected amounts of light, an amount-of-light control circuit adjusts the light sources to avoid image irregularities which would otherwise be caused by differences between the amounts of light of the light beams emitted from the light sources.

### BACKGROUND OF THE INVENTION

1. Field of the Invention

The present invention relates to an exposure recording apparatus for applying light beams emitted from a plurality of respective light sources arrayed in an auxiliary scanning direction to a photosensitive medium in a main scanning direction, thereby to record a two-dimensional image on the photosensitive medium, and a method of adjusting the amount of light of the light beams in the exposure recording apparatus.

2. Description of the Related Art

There have widely been used exposure recording apparatus in which a drum with a photosensitive medium mounted on its outer circumferential surface is rotated about its own axis in a main scanning direction and the photosensitive medium is scanned with a laser beam that has been modulated by an image to be recorded, in an auxiliary scanning direction perpendicular to the main scanning direction, for thereby recording a two-dimensional image on the photosensitive medium.

Some photosensitive mediums for use in such exposure recording apparatus record an image thereon when irradiated with a laser beam whose amount of light is equal to or greater than a predetermined threshold. As shown in FIG. 15 of the accompanying drawings, the amount of light of the laser beam generally has a Gaussian distribution. Since a coloring range of the photosensitive medium changes when the amount of light of the laser beam changes, it is necessary that the laser beam be controlled to keep the amount of light thereof constant upon recording of an image on the photosensitive medium. When a photosensitive medium that produces a color at a density depending on the amount of light of an applied laser beam is used, the amount of light of the laser beam also needs to be controlled in order to achieve a desired density.

There have also been known exposure recording apparatus having a plurality of laser beam sources for simultaneously applying a plurality of laser beams to a photosensitive medium to record an image at a high speed on the photosensitive medium. In the exposure recording apparatus, it is necessary to control the laser beams to have identical as well as constant amounts of light in order to avoid density irregularities in the recorded image.

For equalizing the amounts of light of the laser beams in the exposure recording apparatus, it has heretofore been customary at the time of its factory shipment to record a given image with the exposure recording apparatus and adjust the laser beam sources in order to eliminate density irregularities in the recorded image.

It has been proposed to use as many amount-of-light detecting means as the number of the laser beam sources for detecting the amounts of light of the respective laser beams. However, as the number of such amount-of-light detecting means increases, the cost of the exposure recording apparatus increases. The cost also rises because the sensitivities of the respective amount-of-light detecting means are required to be calibrated with respect to each other. Another problem with the process based on the amount-of-light detecting means is that it is unable to compensate for changes in the amounts of light that may be caused by the aging of the laser beam sources or the replacement of the laser beam sources after factory shipment of the exposure recording apparatus.

### SUMMARY OF THE INVENTION

It is a general object of the present invention to provide an exposure recording apparatus which is capable of adjusting highly accurately the amounts of lights of light beams emitted from respective light sources at any desired time for thereby avoiding image irregularities that would otherwise be caused by differences between the amounts of lights of the light beams emitted from the respective light sources, and a method of adjusting the amounts of lights of the light beams in the exposure recording apparatus.

A major object of the present invention is to provide an exposure recording apparatus which is of an inexpensive structure capable of adjusting highly accurately the amounts of lights of light beams emitted from respective light sources, and a method of adjusting the amounts of lights of the light beams in the exposure recording apparatus.

Another object of the present invention is to provide an exposure recording apparatus which is capable of adjusting highly accurately the amounts of lights of light beams emitted from respective light sources, using fewer amount-of-light detecting means than the light sources, and a method of adjusting the amounts of lights of the light beams in the exposure recording apparatus.

Still another object of the present invention is to provide an exposure recording apparatus which is capable of performing a process of adjusting the amounts of lights of light beams emitted from respective light sources within a short period of time, and a method of adjusting the amounts of lights of the light beams in the exposure recording apparatus.

Yet another object of the present invention is to provide an exposure recording apparatus which is capable of adjusting highly accurately the amounts of lights of light beams emitted from respective light sources, based on the highly accurate detection of the amounts of lights that is not affected by temperatures, and a method of adjusting the amounts of lights of the light beams in the exposure recording apparatus.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a side elevational view of an exposure recording apparatus according to the present invention;

FIG. 2 is a plan view of the exposure recording apparatus according to the present invention;

FIG. 3 is a perspective view of a moving mechanism in the exposure recording apparatus according to the present invention;

FIG. 4 is a side elevational view of the moving mechanism that is retracted out of a beam path in the exposure recording apparatus according to the present invention;

FIG. 5 is a side elevational view of the moving mechanism that is displaced into the beam path in the exposure recording apparatus according to the present invention;

FIG. 6 is a block diagram of a circuit arrangement of the exposure recording apparatus according to the present invention;

FIGS. 7 through 9 are a flowchart of a method of adjusting the amounts of light of light beams in the exposure recording apparatus according to the present invention;

FIG. 10 is a diagram illustrative of an amount-of-light adjusting process in the exposure recording apparatus according to the present invention;

FIG. 11 is a diagram showing a calibrated current-to-amount-of-light conversion table in the exposure recording apparatus according to the present invention;

FIG. 12 is a diagram showing a calibrated current-to-amount-of-light conversion table in the exposure recording apparatus according to the present invention;

FIG. 13 is a side elevational view, partly in cross section, of an amount-of-light detecting means according to another embodiment of the present invention for use in the exposure recording apparatus according to the present invention;

FIG. 14 is a side elevational view of an amount-of-light detecting means according to still another embodiment of the present invention for use in the exposure recording apparatus according to the present invention; and

FIG. 15 is a diagram showing a distribution of the amount of light of a laser beam.

### DESCRIPTION OF THE PREFERRED EMBODIMENTS

Like or corresponding parts are denoted by like or corresponding reference characters throughout views.

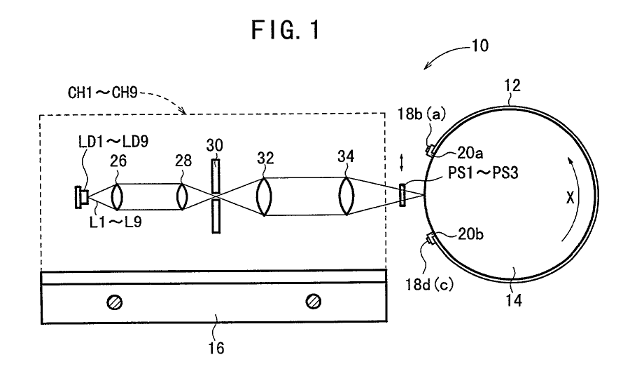

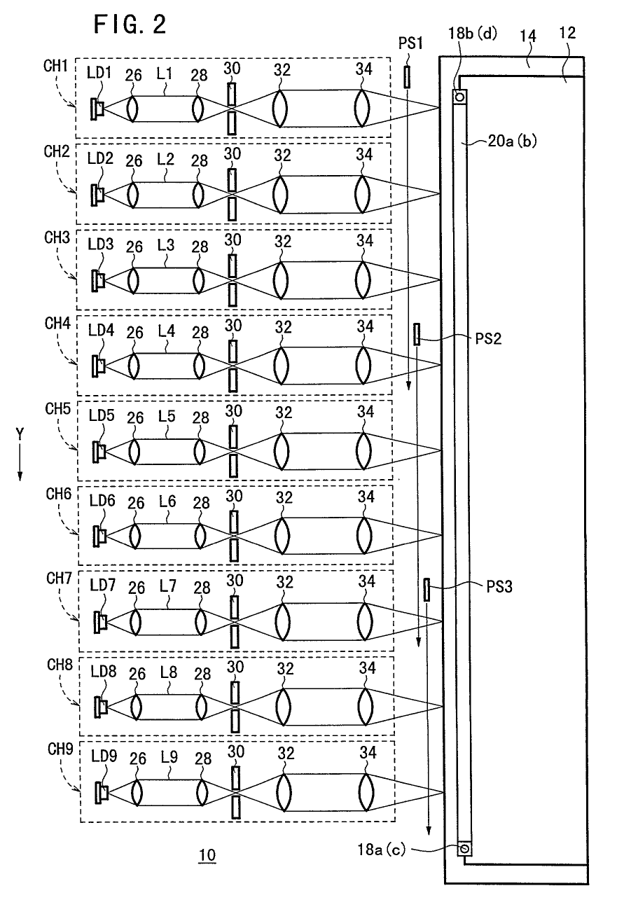

FIGS. 1 and 2 show an exposure recording apparatus 10 according to an embodiment of the present invention.

As shown in FIGS. 1 and 2, the exposure recording apparatus 10 basically comprises a drum 14 rotatable about its own axis in a main scanning direction indicated by the arrow X with a photosensitive medium 12 mounted on its outer circumferential surface, and a plurality of exposure heads CH1-CH9 (light sources) mounted on a carriage 16 that is movable in an auxiliary scanning direction indicated by the arrow Y along the axis of the drum 14.

The photosensitive medium 12 is securely fastened to the drum 14 by clamps 18a-18d that holds fixing plates 20a, 20b against the opposite ends of the photosensitive medium 12. The photosensitive medium 12 may comprise a photosensitive film that is sensitive to light beams applied thereto or a printing plate coated with a photosensitive agent. If the photosensitive medium 12 comprises a printing plate, then the exposure recording apparatus 10 functions as a CTP (Computer to Plate) apparatus for generating a printing plate directly from image data.

The exposure heads CH1-CH9 are arrayed at spaced intervals in the auxiliary scanning direction indicated by the arrow Y. The exposure heads CH1-CH9 comprise respective semiconductor lasers LD1-LD9 for emitting respective laser beams L1-L9 that are turned on and off depending on the image information to be recorded on the photosensitive medium 12. In the present embodiment, each of the laser beams L1-L9 comprises an index-guide-type semiconductor broad-area laser having an amount-of-light distribution that is wide in the auxiliary scanning direction indicated by the arrow Y. However, each of the laser beams L1-L9 may comprise a single-mode semiconductor laser having a Gaussian amount-of-light distribution.

Each of the exposure heads CH1-CH9 has a collimator lens 26, a beam-diameter adjusting lens 28, an aperture member 30, a beam-diameter adjusting lens 32, and a focusing lens 34 that are arranged successively on the optical axis of the corresponding laser beam. Between the exposure heads CH1-CH9 and the drum 14, there are movably disposed photosensors PS1-PS3 (amount-of-light detecting means) such as photodiodes or the like for detecting the amounts of light of the laser beams L1-L9.

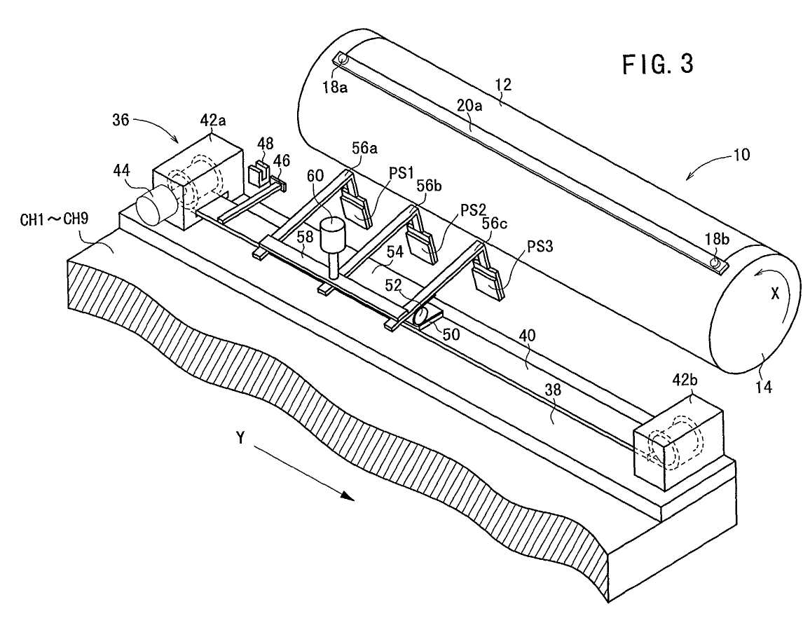

FIGS. 3 through 5 show a moving mechanism 36 for selectively moving the photosensors PS1-PS3 into and out of a position between the exposure heads CH1-CH9 and the drum 14.

The moving mechanism 36 is mounted on a base 38 disposed on upper ends of the exposure heads CH1-CH9. The base 38 is elongate along the array of the exposure heads CH1-CH9, and supports on its opposite ends a pair of take-up units 42a, 42b for a belt 40. The take-up unit 42a which is disposed above the exposure head CH1 has a moving motor 44 (second moving means) for moving the belt 40 in the auxiliary scanning direction indicated by the arrow Y.

A dog 46 is fixed to an upper surface of the belt 40 near the take-up unit 42a. A home position sensor 48 is disposed in a space between the exposure heads CH1-CH9 and the drum 14 near the take-up unit 42a. When the dog 46 is positioned near the home position sensor 48, the home position sensor 48 detects the dog 46, thus detecting when the photosensors PS1-PS3 are in a home position.

An attachment plate 50 is fixed to the upper surface of the belt 40, and arms 56a-56c spaced along the belt 40 are coupled to the attachment plate 50 by a leaf spring 54 that is partly wound around a shaft 52. The arms 56a-56c are substantially L-shaped, and have respective longer members supported on the leaf spring 54 and extending from the exposure heads CH1-CH9 toward the drum 14, and respective shorter members disposed between the exposure heads CH1-CH9 and the drum 14 and supporting the photosensors PS1-PS3, respectively. The distance between the photosensors PS1, PS2 and the distance between the photosensors PS2, PS3 are equal to the distance between the exposure heads CH1, CH4 and the distance between the exposure heads CH4, CH7, respectively (see FIG. 2). The longer members of the arms 56a-56c have ends positioned remotely from the shorter members and interconnected by a joint plate 58. A solenoid 60 (first moving means) for tilting the arms 56a-56c about the shaft 52 is disposed upwardly of a central portion of the joint plate 58.

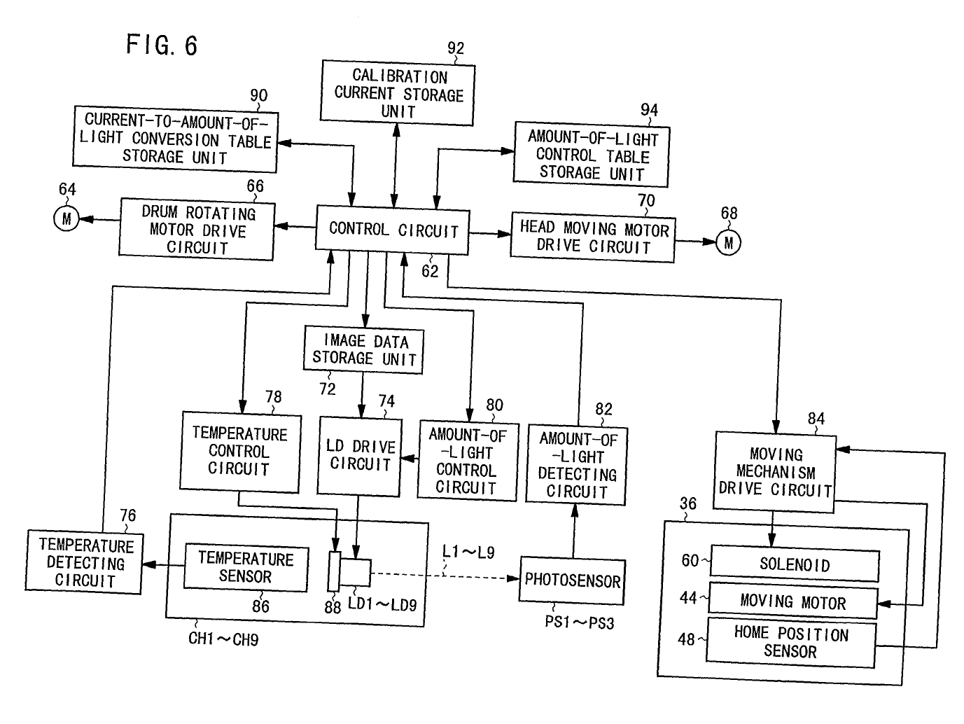

FIG. 6 shows a circuit arrangement of the exposure recording apparatus 10 thus constructed. As shown in FIG. 6, the exposure recording apparatus 10 has a control circuit 62 (amount-of-light correcting means) including a CPU for controlling entire operation thereof. To the control circuit 62, there are connected a drum rotating motor drive circuit 66 for energizing a drum rotating motor 64 to rotate the drum 14 about its own axis in the main scanning direction indicated by the arrow X, and a head moving motor drive circuit 70 for energizing a head moving motor 68 to move the carriage 16 with the exposure heads CH1-CH9 in the auxiliary scanning direction indicated by the arrow Y.

The control circuit 62 is connected to an image data storage unit 72 connected to an LD drive circuit 74. The LD drive circuit 74 turns on and off the semiconductor lasers LD1-LD9 according to image data read from the image data storage unit 72.

The control circuit 62 is also connected to a temperature detecting circuit 76, a temperature controlling circuit 78, an amount-of-light controlling circuit 80 (amount-of-light adjusting means), an amount-of-light detecting circuit 82, and a moving mechanism drive circuit 84.

The temperature detecting circuit 76 detects a temperature based on a signal from a temperature sensor 86 (temperature detecting means) disposed closely to each of the semiconductor lasers LD1-LD9. The temperature controlling circuit 78 controls a temperature regulating device 88 (temperature regulating means) such as Peltier device or the like combined with each of the semiconductor lasers LD1-LD9 in order to bring the temperature of the semiconductor lasers LD1-LD9 as detected by the temperature sensor 86 into conformity with a predetermined temperature. The amount-of-light detecting circuit 82 detects the amounts of light of the laser beams L1-L9 based on signals from the photosensors PS1-PS3. The amount-of-light controlling circuit 80 controls drive currents supplied from the LD drive circuit 74 to the semiconductor lasers LD1-LD9 in order to equalize the amounts of light of the laser beams L1-L9 as detected by the photosensors PS1-PS3. The moving mechanism drive circuit 84 energizes the moving motor 44 and the solenoid 60 based on a detected home position signal from the home position sensor 48 to move the photosensors PS1-PS3 of the moving mechanism 36 with respect to desired ones of the exposure heads Ch1-CH9.

The control circuit 62 is further connected to a current-to-amount-of-light conversion table storage unit 90, a calibration current storage unit 92, and an amount-of-light control table storage unit 94. The current-to-amount-of-light conversion table storage unit 90 stores a table for converting currents detected by the photosensors PS1-PS3 into amounts of lights of the laser beams L1-L9. The calibration current storage unit 92 stores calibration currents for calibrating sensitivity differences between the photosensors PS1-PS3. The amount-of-light control table storage unit 94 stores an amount-of-light control table for equalizing the amounts of lights of the laser beams L1-L9.

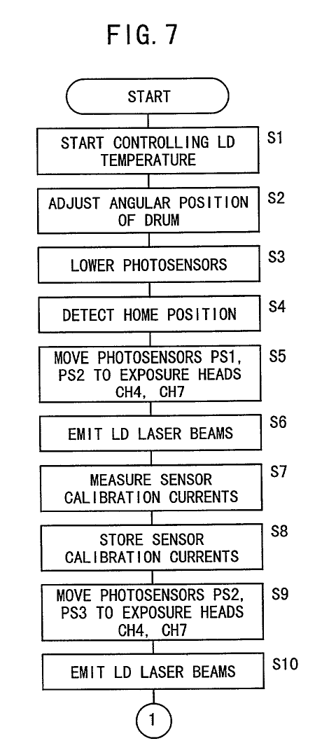

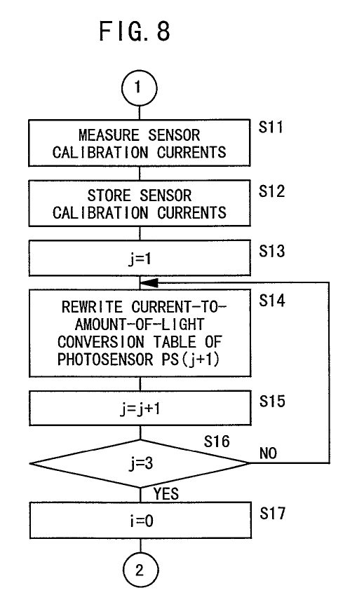

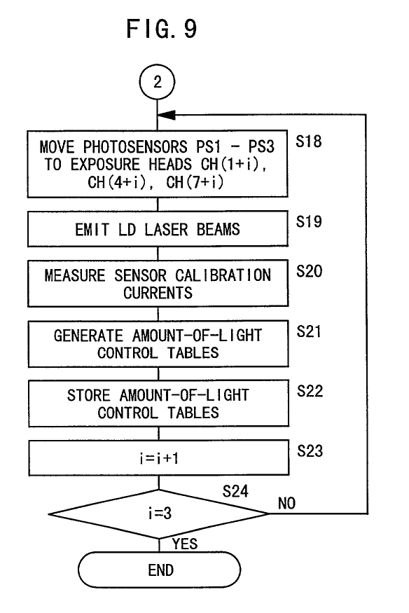

The exposure recording apparatus 10 is basically constructed as described above. Operation of the exposure recording apparatus 10 will be described below with reference to a flowchart of an operation sequence shown in FIGS. 7 through 9.

First, the control circuit 62 starts a process of controlling the semiconductor lasers LD1-LD9 at a predetermined temperature in step S1 (FIG. 7). The temperature sensor 86 detects the temperatures of the semiconductor lasers LD1-LD9, and outputs detected signals via the temperature detecting circuit 76 to the control circuit 62. From the detected signals, the control circuit 62 generates temperature control signals for controlling the semiconductor lasers LD1-LD9 at the predetermined temperature, and supplies the temperature control signals via the temperature control circuit 78 to the temperature regulating devices 88 of the respective semiconductor lasers LD1-LD9 to control the temperatures of the semiconductor lasers LD1-LD9.

While the control circuit 62 is thus controlling the temperatures of the semiconductor lasers LD1-LD9, the control circuit 62 enables the drum rotating motor drive circuit 66 to control the drum rotating motor 64 to rotate the drum 14 through a certain angular interval so that the clamps 18a-18d and the fixing plates 20a, 20b which fix the photosensitive medium 12 to the drum 14 are not positioned in the vicinity of the exposure heads CH1-CH9 in step S2.

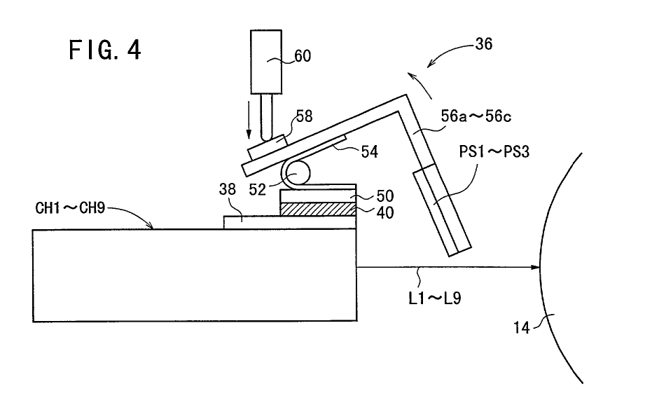

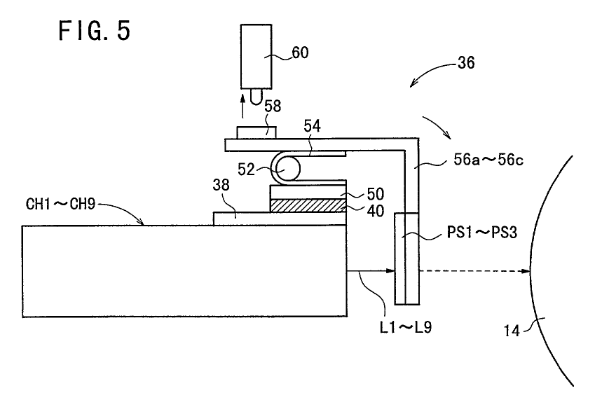

After having adjusted the angular position of the drum 14, the control circuit 62 enables the moving mechanism drive circuit 84 to energize the solenoid 60 to lower the photosensors PS1-PS3 from the position shown in FIG. 4 to the position shown in FIG. 5 in step S3. Specifically, when the solenoid 60 is energized, its rod is lifted from the position shown in FIG. 4, allowing the arms 56a-56c to turn clockwise about the shaft 52 under the resiliency of the leaf spring 54. The photosensors PS1-PS3 mounted on the shorter members of the arms 56a-56c are now lowered into a position between the exposure heads CH1-CH9 and the drum 14, as shown in FIG. 5. Since the clamps 18a-18d and the fixing plates 20a, 20b have been displaced away from the exposure heads CH1-CH9 in step S2, the photosensors PS1-PS3 are prevented from contacting the clamps 18a-18d and the fixing plates 20a, 20b.

Then, the control circuit 62 enables the moving mechanism drive circuit 84 to energize the moving motor 44 to move the belt 40. When the dog 46 attached to the belt 40 is positioned in the vicinity of the home position sensor 48, the control circuit 62 de-energizes the moving motor 44 based on a signal from the home position sensor 48. The moving mechanism 36 is now placed in its home position in step S4.

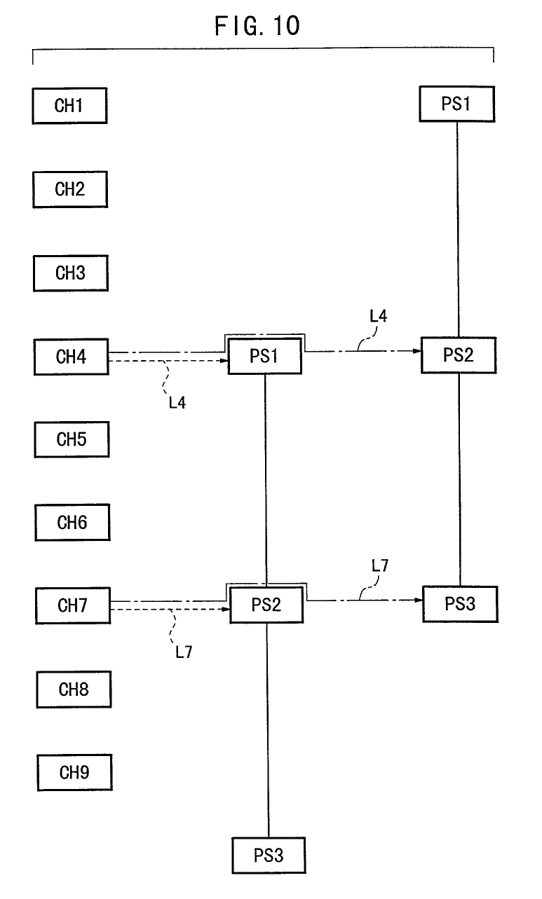

After the moving mechanism 36 has been placed in the home position, the control circuit 62 energizes the moving motor 44 again to move the photosensors PS1, PS2 to respective positions between the exposure heads CH4, CH7 and the drum 14 as shown in FIG. 10 in step S5.

After having thus positioned the photosensors PS1, PS2, the control circuit 62 supplies test data from the image data storage unit 72 to turn on the LD drive circuit 74, and also supplies a certain control current I_{L} from the amount-of-light control circuit 80 to circuit sections of the LD drive circuit 74 which correspond to the semiconductor lasers LD4, LD7. The LD drive circuit 74 then supplies injection currents based on the control current I_{L} into the semiconductor lasers LD4, LD7 of the exposure heads CH4, CH7, whereupon only the semiconductor lasers LD4, LD7 emit respective laser beams L4, L7 in step S6. Because only the semiconductor lasers LD4, LD7 emit the respective laser beams L4, L7, the other exposure heads where the photosensors PS1-PS3 are not positioned do not apply laser beams to the drum 14 and hence do not unduly burn the drum 14.

The amount-of-light detecting circuit 82 detects the amounts of light of the respective laser beams L4, L7 emitted from the semiconductor lasers LD4, LD7 as sensor calibration currents I₄₁, I₇₂ through the photosensors PS1, PS2, and supplies the sensor calibration currents I₄₁, I₇₂ to the control circuit 62 in step S7. The control circuit 62 stores the supplied sensor calibration currents I₄₁, I₇₂ in the calibration current storage unit 92 in step S8. Left suffixes of the sensor calibration currents refer to the numbers of the exposure heads CH1-CH9, and right suffixes thereof to the numbers of the photosensors PS1-PS3.

After having turned off the semiconductor lasers LD4, LD7, the control circuit 62 moves the photosensors PS2, PS3 to respective positions between the exposure heads CH4, CH7 and the drum 14 as shown in FIG. 10 in step S9. As is the case with the processing in steps S6-S8, the control circuit 62 supplies a constant control current I_{L} to the LD drive circuit 74 to cause the semiconductor lasers LD4, LD7 to emit respective laser beams L4, L7 in step S10, detects the amounts of light of the laser beams L4, L7 as sensor calibration currents I₄₂, I₇₃ in step S11, and stores the sensor calibration currents I₄₂, I₇₃ in the calibration current storage unit 92 in step S12.

After having thus determined the sensor calibration currents I₄₁, I₇₂, I₄₂, I₇₃, the control circuit 62 calibrates sensitivity differences between the photosensors PS1-PS3 as follows:

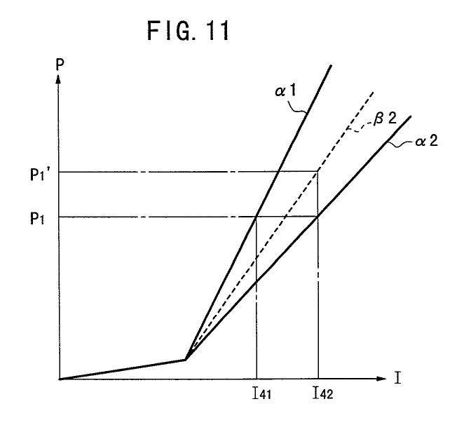

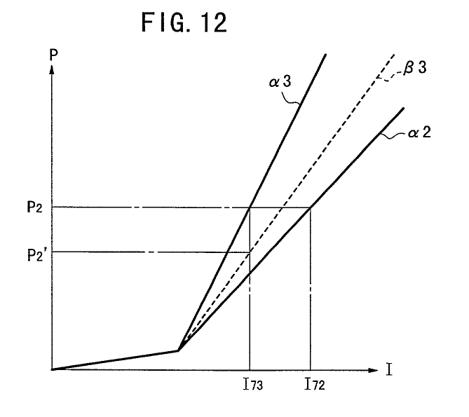

As shown in FIGS. 11 and 12, the current-to-amount-of-light conversion table storage unit 90 stores current-to-amount-of-light conversion tables α1, β2, β3 representing the relationship between currents I detected respectively by the photosensors PS1-PS3 and amounts P of light of corresponding laser beams, as default tables for the photosensors PS1-PS3. The control circuit 62 calibrates the sensitivities of the photosensors PS2, PS3 based on the current-to-amount-of-light conversion table α1 of the photosensor PS1.

First, the control circuit 62 sets j to j=1 in step S13, and rewrites the current-to-amount-of-light conversion table β2 of the photosensor PS2 to determine a calibrated current-to-amount-of-light conversion table α2 in step S14.

Specifically, as shown in FIG. 11, if the amount of light of the laser beam L4 as detected by the photosensor PS1 with respect to the sensor calibration current I₄₁ is represented by P₁, then the current-to-amount-of-light conversion table β2 is corrected to set the amount P₁′ of light as detected by the photosensor PS2 with respect to the sensor calibration current I₄₂ to P₁. Amounts of light on the current-to-amount-of-light conversion table β2 with respect to other sensor calibration currents are determined according to proportional calculations, thus correcting the current-to-amount-of-light conversion table β2 into a new current-to-amount-of-light conversion table α2. With the current-to-amount-of-light conversion table β2 thus corrected, the sensitivity differences of the photosensor PS2 with the photosensor PS1 can be calibrated.

Then, the control circuit 62 sets j to j=2 in step S15, and rewrites the current-to-amount-of-light conversion table β3 of the photosensor PS3 to determine a calibrated current-to-amount-of-light conversion table α3 in step S14.

Specifically, as shown in FIG. 12, if the amount of light of the laser beam L7 as detected by the photosensor PS2 with respect to the sensor calibration current I₇₂ is represented by P₂, then the current-to-amount-of-light conversion table β3 is corrected to set the amount P₂′ of light as detected by the photosensor PS3 with respect to the sensor calibration current I₇₃ to P₂. Amounts of light on the current-to-amount-of-light conversion table β3 with respect to other sensor calibration currents are determined according to proportional calculations, thus correcting the current-to-amount-of-light conversion table β3 into a new current-to-amount-of-light conversion table α3. With the current-to-amount-of-light conversion table β3 thus corrected, the sensitivity differences of the photosensor PS3 with the photosensor PS2 can be calibrated. As a result, the sensitivity differences of the photosensors PS2, PS3 with the photosensor PS1, used as a reference, can be calibrated.

After having thus rewritten the current-to-amount-of-light conversion table β2, α3 in step S16, the control circuit 62 sets i to i=0 in step S17. Thereafter, the control circuit 62 adjusts the amounts of light of the laser 20 beams L1-L9 as follows:

First, the control circuit 62 moves the photosensors PS1-PS3 to respective positions between the exposure heads CH1, CH4, CH7 and the drum 14 in step S18. Then, the control circuit 62 supplies a constant control current I_{L} from the amount-of-light controlling circuit 80 to the LD drive circuit 74, which energizes the semiconductor lasers LD1, LD4, LD7 to emit respective laser beams L1, L4, L7 in step S19. The emitted laser beams L1, L4, L7 are detected by the respective photosensors PS1-PS3. The control circuit 62 detects the amounts of light of the laser beams L1, L4, L7 as LD calibration currents in step S20. Then, the control circuit 62 adjusts the control current I_{L} supplied to the LD drive circuit 74, and determines control currents I_{L1}, I_{L4}, I_{L7} capable of obtaining desired amounts of light from the detected LD calibration currents, as amount-of-light control tables using the current-to-amount-of-light conversion tables α1-α3 in step S21. Right suffixes of the control currents I_{L} refer to the numbers of the semiconductor lasers LD1-LD9. The determined control currents I_{L1}, I_{L4}, I_{L7} are stored in the amount-of-light control table storage unit 94 in step S22.

Then, the control circuit 62 sets i to i=1 in step S23, and moves the photosensors PS1-PS3 to respective positions between the exposure heads CH2, CH5, CH8 and the drum 14 in step S18. Thereafter, the control circuit 62 determines control currents I_{L2}, I_{L5}, I_{L8} as amount-of-light control tables in steps S19-S21.

The same processing is repeated until i=3 in step S24, thereby generating amount-of-light control tables of control currents I_{L1}-I_{L9} which are capable of equalizing the amounts of light of all the laser beams L1-L9.

A process of recording an image on the photosensitive medium 12 by way of exposure using the amount-of-light control tables thus generated will be described below.

Prior to the image recording process, the control circuit 62 de-energizes the solenoid 60 to move the arms 56a-56c of the moving mechanism 36 from the position shown in FIG. 5 to the position shown in FIG. 4 thereby retracting the photosensors PS1-PS3 out of the beam path of the laser beams L1-L9. Then, the operator attaches the photosensitive medium 12 to the outer circumferential surface of the drum 14, and secures the photosensitive medium 12 in position by pressing the fixing plates 20a, 20b against the photosensitive medium 12 with the clamps 18a-18d.

After the above preparatory action, the control circuit 62 controls the drum rotating motor drive circuit 66 to energize the drum rotating motor 64 to rotate the drum 14 about its own axis, together with the photosensitive medium 12, in the main scanning direction indicated by the arrow X.

The control circuit 62 controls the image data storage unit 72 to supply an image signal to the LD drive circuit 74. The control circuit 62 supplies the control currents I_{L1}-I_{L9} to the amount-of-light control circuit 80 according to the amount-of-light control tables stored in the amount-of-light control table storage unit 94. The LD drive circuit 74 is turned on and off by the image signal, and supplies injection currents controlled by the control currents I_{L1}-I_{L9} to the respective semiconductor lasers LD1-LD9. As a result, the semiconductor lasers LD1-LD9 emits laser beams L1-L9 whose amounts of light have been calibrated with respect to each other. The laser beams L1-L9 thus emitted are converted into parallel beams by the collimator lens 26, and led to the photosensitive medium 12 through the beam diameter adjusting lens 28, the aperture member 30, the beam-diameter adjusting lens 32, and the focusing lens 34.

The control circuit 62 controls the head moving motor drive circuit 70 to energize the head moving motor 68 to move the carriage 16 in the auxiliary scanning direction indicated by the arrow Y. Therefore, nine main scanning lines are simultaneously formed on the photosensitive medium 12. Since the main scanning lines are moved in the auxiliary scanning direction indicated by the arrow Y, a two-dimensional image is created on the photosensitive medium 12. Inasmuch as the amounts of light of the laser beams L1-L9 have been adjusted with respect to each other, the produced image is free of density irregularities.

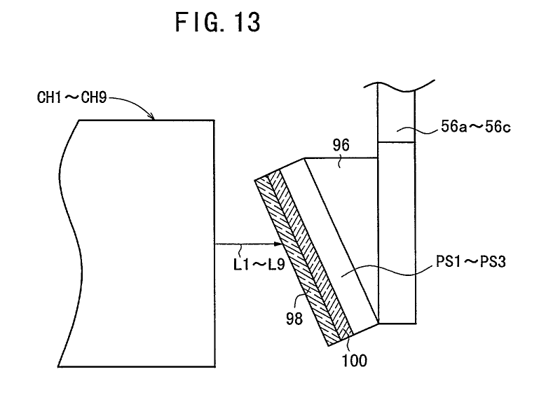

In the above embodiment, the photosensors PS1-PS3 interposed between the exposure heads CH1-CH9 and the drum 14 have their sensitive surfaces lying perpendicularly to the laser beams L1-L9. FIG. 13 shows photosensors PS1-PS3 according to another embodiment of the present invention. As shown in FIG. 13, the photosensors PS1-PS3 are mounted on a slanted support base 96 to have their sensitive surfaces inclined to the laser beams L1-L9 for detecting the amounts of light of the laser beams L1-L9 more accurately. Specifically, because the photosensors PS1-PS3 are inclined to the laser beams L1-L9, the laser beams L1-L9 are not repeatedly reflected between the exposure heads CH1-CH9 and the photosensors PS1-PS3, so that unwanted light is prevented from reentering the photosensors PS1-PS3.

An anti-reflection layer 98 is disposed on each of the sensitive surfaces of the photosensors PS1-PS3 for further minimizing the effect of unwanted light on the photosensors PS1-PS3. Depending on the amounts of light of the laser beams L1-L9, the photosensors PS1-PS3 may possibly be saturated by excessively large currents detected thereby. To avoid such a drawback, a neutral density filter (ND filter) 100 (light reducing means) is interposed between each of the sensitive surfaces of the photosensors PS1-PS3 and the anti-reflection layer 98 for reducing the amount of light falling on the photosensors PS1-PS3.

In the above embodiment, the temperature of the semiconductor lasers LD1-LD9 is detected by the temperature sensor 86, and the temperature regulating device 88 is controlled to keep the detected temperature constant for thereby stabilizing the amounts of light of the laser beams L1-L9. However, the temperature of the semiconductor lasers LD1-LD9 may be controlled without the use of the temperature regulating device 88. Specifically, the relation between the temperature and the amount of light is determined with respect to each of the semiconductor lasers LD1-LD9, and preset as a temperature-vs.-amount-of-light table. Based on the temperature-vs.-amount-of-light table, the control current I_{L} supplied from the amount-of-light controlling circuit 80 to the LD drive circuit 74 in order to make constant the amounts of light of the laser beams L1-L9.

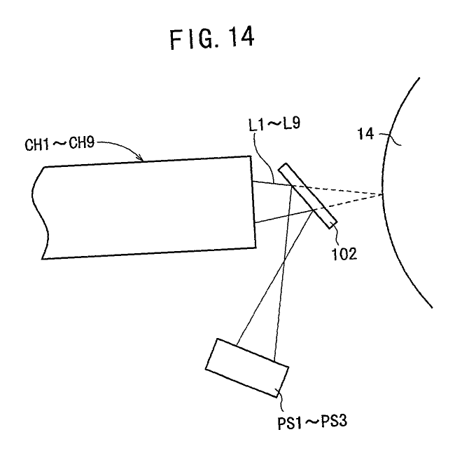

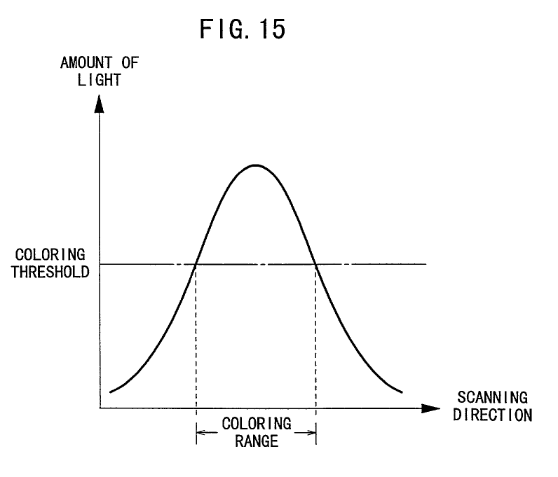

FIG. 14 shows an amount-of-light detecting means according to still another embodiment of the present invention. In FIG. 14, a reflecting mirror 102 is disposed for movement into and out of a position between the exposure heads CH1-CH9 and the drum 14. When the reflecting mirror 102 is disposed between the exposure heads CH1-CH9 and the drum 14, it reflects the laser beams L1-L9 emitted from the exposure heads CH1-CH9 toward the photosensors PS1-PS3, which detect the amounts of light of the laser beams L1-L9.

Even if the gap between the exposure heads CH1-CH9 and the drum 14 is small, the reflecting mirror 102 can easily be placed therebetween.

In the embodiment shown in FIG. 14, the reflecting mirror 102 may be replaced with a beam splitter or an absorption filter for adjusting the amounts of light of the laser beams L1-L9 reflected thereby or passing therethrough and guiding the adjusted laser beams L1-L9 to the photosensors PS1-PS3. If a beam splitter is employed, then it is combined with an ND filter with the beam splitter used as a light absorbing member in order to prevent the laser beams L1-L9 passing through the beam splitter from burning the surface of the drum 14. Alternatively, the surface of the beam splitter which faces the drum 14 may be processed to a frosted finish to diffuse the laser beams L1-L9.

In the above embodiments, the amounts of light of the laser beams L1-L9 emitted from the semiconductor lasers LD1-LD9 are detected by the fewer photosensors PS1-PS3 than the semiconductor lasers LD1-LD9 for adjusting the amounts of light of the laser beams L1-L9. However, if a sufficient time is available for adjustments, then the amounts of light of the laser beams L1-L9 may be detected by a single photosensor for adjusting the amounts of light of the laser beams L1-L9.

As described above, the amount-of-light detecting means is inserted between the light sources and the photosensitive medium at any desired time to detect the amounts of light of the light beams emitted from the light sources for adjusting the amounts of light of the light beams. Therefore, the amounts of light of the light beams can be adjusted at any time desired by the user as well as at the time of factory shipment of the exposure recording apparatus. The amounts of light of the light beams emitted from the light sources can be adjusted highly accurately to avoid image irregularities which would otherwise be caused by differences between the amounts of light of the light beams emitted from the light sources.

If a plurality of amount-of-light detecting means are used to repeatedly detect the amounts of light of predetermined ones of the light beams emitted from the light sources, then the sensitivity differences between the amount-of-light detecting means can be corrected to adjust the amounts of light of the light beams quickly.

Although certain preferred embodiments of the present invention have been shown and described in detail, it should be understood that various changes and modifications may be made therein without departing from the scope of the appended claims.

What is claimed is:

1. An exposure recording apparatus for applying light beams emitted from a plurality of respective light sources arrayed in an auxiliary scanning direction to a photosensitive medium in a main scanning direction substantially perpendicular to the auxiliary scanning direction for thereby recording a two-dimensional image on the photosensitive medium, comprising:
amount-of-light detecting means movable into and out of a beam path of the light beams, for detecting amounts of light of the light beams emitted from said light sources;
a moving mechanism for moving said amount-of-light detecting means movable into and out of said beam path; and
amount-of-light adjusting means for adjusting the amounts of light of the light beams emitted from said light sources in order to equalize the amounts of light of the light beams detected by said amount-of-light detecting means.

2. An exposure recording apparatus according to claim 1, comprising a plurality of said amount-of-light detecting means.

3. An exposure recording apparatus according to claim 2, wherein the number of said amount-of-light detecting means is smaller than the number of said light sources, and said moving mechanism comprises means for moving said amount-of-light detecting means repeatedly into and out of said beam path of predetermined ones of the light beams.

4. An exposure recording apparatus according to claim 2, wherein said amount-of-light adjusting means has current-to-amount-of-light conversion tables associated with the respective amount-of-light detecting means, for converting currents detected by said amount-of-light detecting means into amounts of light of said light beams, and means for rewriting said current-to-amount-of-light conversion tables in order to equalize the amounts of light which are converted from the currents detected by said amount-of-light detecting means by said current-to-amount-of-light conversion tables.

5. An exposure recording apparatus according to claim 1, wherein said moving mechanism comprises:
first moving means for moving said amount-of-light detecting means movable into and out of said beam path; and
second moving means for moving said amount-of-light detecting means in said auxiliary scanning direction.

6. An exposure recording apparatus according to claim 1, wherein said amount-of-light detecting means comprises:
a photosensor movable into said beam path obliquely with a sensitive surface thereof lying not perpendicularly to said light beams.

7. An exposure recording apparatus according to claim 1, wherein said amount-of-light detecting means comprises:
a reflecting mirror movable into said beam path obliquely with a sensitive surface thereof lying not perpendicularly to said light beams; and
a photosensor for detecting the amounts of light of said light beams reflected by said reflecting mirror.

8. An exposure recording apparatus according to claim 1, wherein said amount-of-light detecting means comprises:
light reducing means disposed on a sensitive surface thereof for reducing the amount of light falling thereon.

9. An exposure recording apparatus according to claim 1, further comprising:
temperature detecting means for detecting a temperature of each of said light sources; and
amount-of-light correcting means for correcting the amounts of light of said light beams detected by said amount-of-light detecting means into an amount of light at the detected temperature.

10. An exposure recording apparatus according to claim 9, wherein said amount-of-light correcting means comprises:
a temperature-vs.-amount-of-light table representing the relation between said temperature and each of said amounts of light.

11. An exposure recording apparatus according to claim 1, further comprising:
temperature detecting means for detecting a temperature of each of said light sources; and
temperature regulating means for regulating each of said light sources at a predetermined temperature based on the detected temperature.

12. A method of adjusting amounts of light in an exposure recording apparatus for applying light beams emitted from a plurality of respective light sources arrayed in an auxiliary scanning direction to a photosensitive medium in a main scanning direction substantially perpendicular to the auxiliary scanning direction for thereby recording a two-dimensional image on the photosensitive medium, comprising the steps of:
inserting amount-of-light detecting means for detecting amounts of light of the light beams emitted from said light sources between said light sources and said photosensitive medium;
detecting the amounts of light of the light beams emitted from said light sources with said amount-of-light detecting means; and
adjusting said light sources in order to equalize the amounts of light of the light beams detected by said amount-of-light detecting means.

13. A method according to claim 12, further comprising the step of:
before the step of detecting the amounts of light, controlling a temperature of each of said light sources.

14. A method according to claim 12, wherein said step of detecting the amounts of light comprises the step of:
controlling only those light sources which correspond to regions where said amount-of-light detecting means are inserted, to emit the light beams.

15. A method according to claim 12, wherein said plurality of amount-of-light detecting means movable with respect to said light sources, further comprising the steps of:
prior to said step of detecting the amounts of light, detecting the amount of light of the light beam emitted from one of said light sources with said plurality of amount-of-light detecting means, and adjusting said amount-of-light detecting means in order to equalize the detected amounts of light.
